(19) United States
(12) Patent Application Publication
(10) Pub. No.: US 2026/0051906 A1
(43) Pub. Date: Feb. 19, 2026

(54) SIGNAL PROCESSING OF FRAGMENTED DOWNLINK CARRIERS

(71) Applicant: Apple Inc., Cupertino, CA (US)

(72) Inventors: Fucheng Wang, Cupertino, CA (US); Elmar Wagner, Taufkirchen (DE); Anatoliy S. Ioffe, Sunnyvale, CA (US)

(73) Assignee: Apple Inc., Cupertino, CA (US)

(21) Appl. No.: 18/807,658

(22) Filed: Aug. 16, 2024

(51) Int. Cl. H04B 1/00; H04B 1/66; H04L 5/14

(52) U.S. Cl. CPC H04B 1/0075; H04B 1/662; H04L 5/14

(57) ABSTRACT

Techniques for described for combining fragmented carriers. An example method can include processing, using a first local oscillator (LO), a first analog signal and a second analog signal that are separated by a frequency offset, an output of the first LO used to generate a first digital signal and a second digital signal. The method can further include downshifting the first digital signal based on the center frequency to generate a downshifted digital signal. The method can further include upshifting the second digital signal based on the center frequency to generate an upshifted digital signal. The method can further include combining the downshifted signal and the upshifted signal to generate a combined digital signal, wherein the downshifted digital signal is orthogonal to the upshifted digital signal, and wherein a second total bandwidth of the combined digital signal is less than the threshold bandwidth.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of a downlink transmission from a base station to a UE, according to one or more embodiments.

FIG. 2 is an illustration of processing circuitry for a UE, according to one or more embodiments.

FIG. 3 is an illustration of processing circuitry for a UE, according to one or more embodiments.

FIG. 4 is an illustration of processing circuitry for a UE, according to one or more embodiments.

FIG. 5 is an illustration of processing circuitry for a UE, according to one or more embodiments.

FIG. 6 is an illustration of a reduction in total bandwidth, according to one or more embodiments.

FIG. 7 is a process for combining fragmented carriers, according to one or more embodiments.

FIG. 8 is a process for combining fragmented carriers, according to one or more embodiments.

FIG. 9 is an illustration of an example of receive components, according to one or more embodiments.

FIG. 10 is an illustration of an example of a user equipment, according to one or more embodiments.

FIG. 11 is an illustration of an example of a network node, according to one or more embodiments.

### DETAILED DESCRIPTION

Fragmented spectrum blocks can include blocks in a single frequency band, in which the blocks belong to the same network operator. The fragmented spectrum blocks can be considered as an intra-band, non-contiguous combination, in which each of the spectrum blocks are processed separately by a digital front end of a user equipment (UE). The digital front-end can include an interface between an analog front-end and digital baseband circuitry. In some instances, the fragmented spectrum blocks can be for sub-carriers used under an orthogonal frequency-division multiplexing (OFDM) transmission scheme. Processing multiple aggregated spectrum blocks can require a high amount of UE hardware complexity. One issue that can occur is that if the total bandwidth of any carriers separated by a gap are greater than a threshold bandwidth, the UE's processing circuitry may be unable to process the signal due to hardware limitations. As such, it may be advantageous to define fragmented spectrum blocks in a band as a single carrier provided that a total aggregated bandwidth, including a frequency gap between fragmented carriers, does not exceed a maximum single carrier channel bandwidth (CBW) in frequency range 1 (FR1).

The embodiments described herein address the above referenced issues by providing techniques for enabling the UE to cause a shift in the frequency ranges of fragmented carriers to reduce width of the gap separating the carriers, such that the total bandwidth of the carriers and the gap, if any, is below the threshold bandwidth. In particular, the embodiments describe an analog signal path with a frequency down-conversion mixer and a local oscillator (LO) followed by a pair of tunable complex bandpass intermediate frequency (IF) filters and a pair of analog to digital convertors (ADCs) to digitize each of the carriers. The embodiments described herein also describe an analog signal path with a pair of frequency down-conversion mixers and dual LOs, followed by a pair of tunable filters and a pair of ADCs to digitize each of the DL carriers. Each of the embodiments can respectively be used by a UE to process a signal that includes fragmented carriers that are separated by gap, such that the total bandwidth of the carriers and the gap exceeds a threshold bandwidth. Each of the above described circuits can be used by a UE to reduce the total bandwidth to less than a threshold bandwidth.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

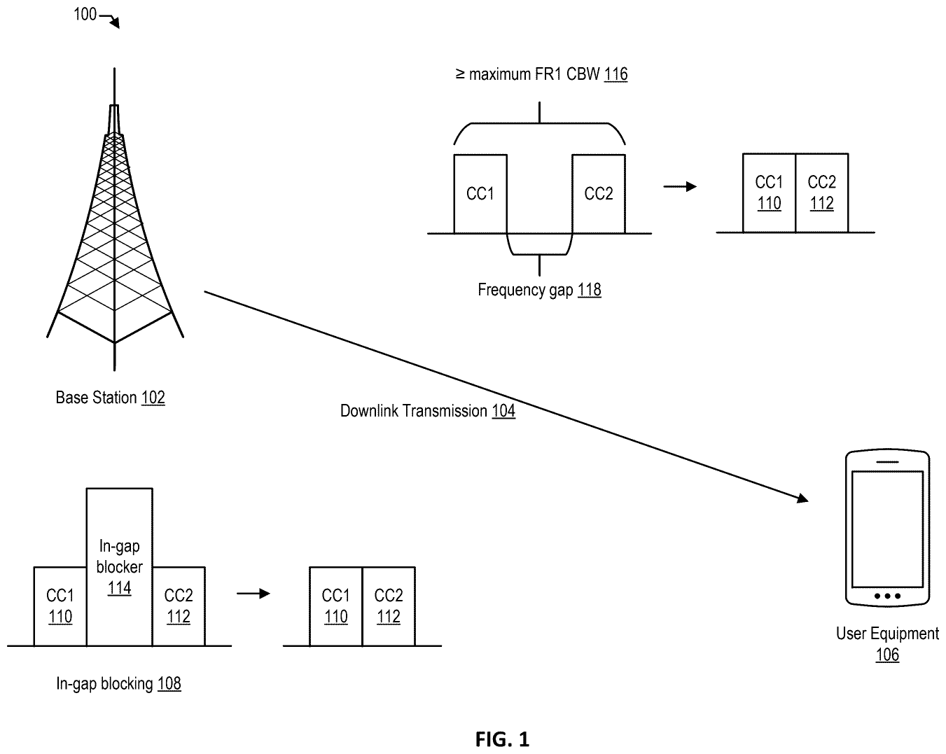

FIG. 1 is an illustration 100 of a downlink (DL) transmission over a channel from a base station to a UE, according to one or more embodiments. As illustrated, a base station 102 can transmit a DL transmission 104 over a channel to a UE 106. The DL transmission 104 can include fragmented spectrum blocks transmitted across a single frequency band. Various issues can arise at a UE 106 that is processing the fragmented spectrums blocks. A first issue can include in-gap blocking 108. As illustrated, the base station 102, which can be operated by a first operator, can transmit a signal over fragmented carriers (e.g., first component carrier (CC) 110, second CC 112), where there is a frequency gap between the blocks. The frequency gap between fragmented carriers can be occupied by a second operator's DL signal (e.g., in-gap blocker 114), where the different operator's DL signal has greater power than the signal from base station 102. This situation may occur when the UE 106 is located near a serving cell provided by the second operator. It should be appreciated that as used herein, the term “gap” can be a set of frequencies between two signals in the digital domain. Additionally, the term “gap” may refer to a frequency offset between two signals in the frequency domain.

In this situation, if the UE 106 were to attempt to process the fragmented DL carriers as a single carrier in the analog domain, the UE's processing circuitry may not be able to properly distinguish the signals (e.g., CC1 110, in-gap blocker 114, and CC2 112). For example, the UE's analog-to-digital convertor (ADC) may not have the dynamic range to accommodate the desired fragmented carriers and the unwanted in-gap blocker 114. This can result in the UE 106 outputting incorrect information.

A second issue can be the bandwidth of the fragmented carriers exceeds a maximum allowable carrier bandwidth (CBW) 116 in the first frequency range (FR1). For example, for a new radio (NR) frequency division duplex (FDD) operation, the carrier bandwidth may be set to 50 MHz. For a channel bandwidth, for fragmented carriers, that is wider than 50 MHz, the subcarrier spacing (SCS) would be 30 KHz or higher. However, an SCS that is 30 KHz or higher is not currently supported by the 5G ecosystem for FDD bands. Furthermore, using a 15 KHz SCS for a CBW wider than 50 MHz, can result in number of points (N) used in fast Fourier transform (FFT) computation to exceed a current allowable limit of 4096 points. The bands with fragmented DL carriers proposed in the release (Rel)-19 study item are n7 and n66, where both the aggregated bandwidth (BW) including an in-between gap exceeds 50 MHz, while the aggregated BW without a gap 118 is less than 50 Mhz.

Embodiments herein address the above-referenced issues by providing techniques for demodulating a radio frequency signal that includes two or more fragmented DL carriers as a single carrier. In particular, the embodiments herein described techniques for enabling the UE to cause a shift in the frequency ranges of fragmented carriers to reduce width of the gap 118 separating the carriers, such that the total bandwidth of the carriers and the gap 118, if any, is below the threshold bandwidth. The techniques can be used to remove an in-gap blocker 114, if any between two fragmented carriers. The techniques can also be used to shift the ranges of the carriers to reduce the width of the gap 118 to cause the total bandwidth of the carriers and any gap 118 to be below a threshold bandwidth.

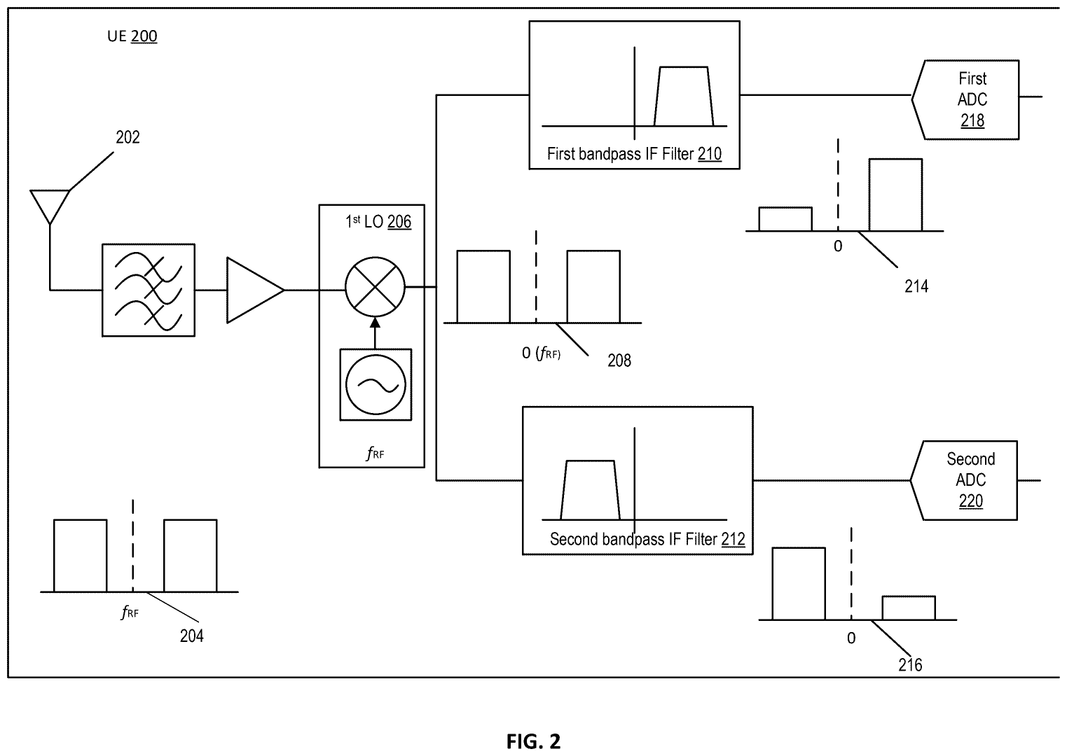

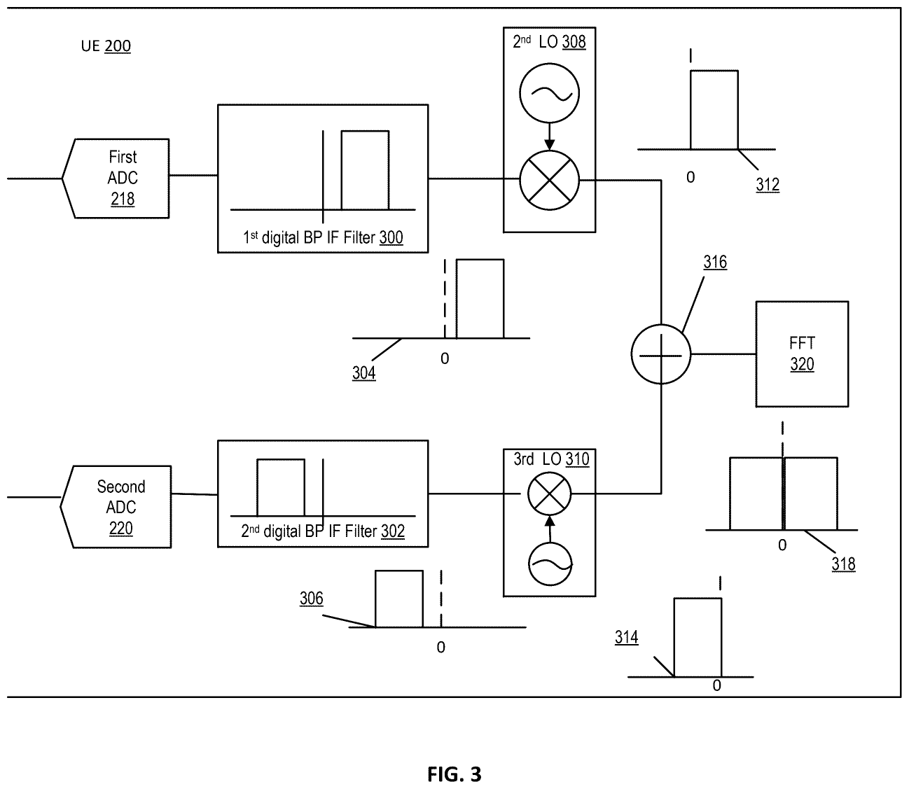

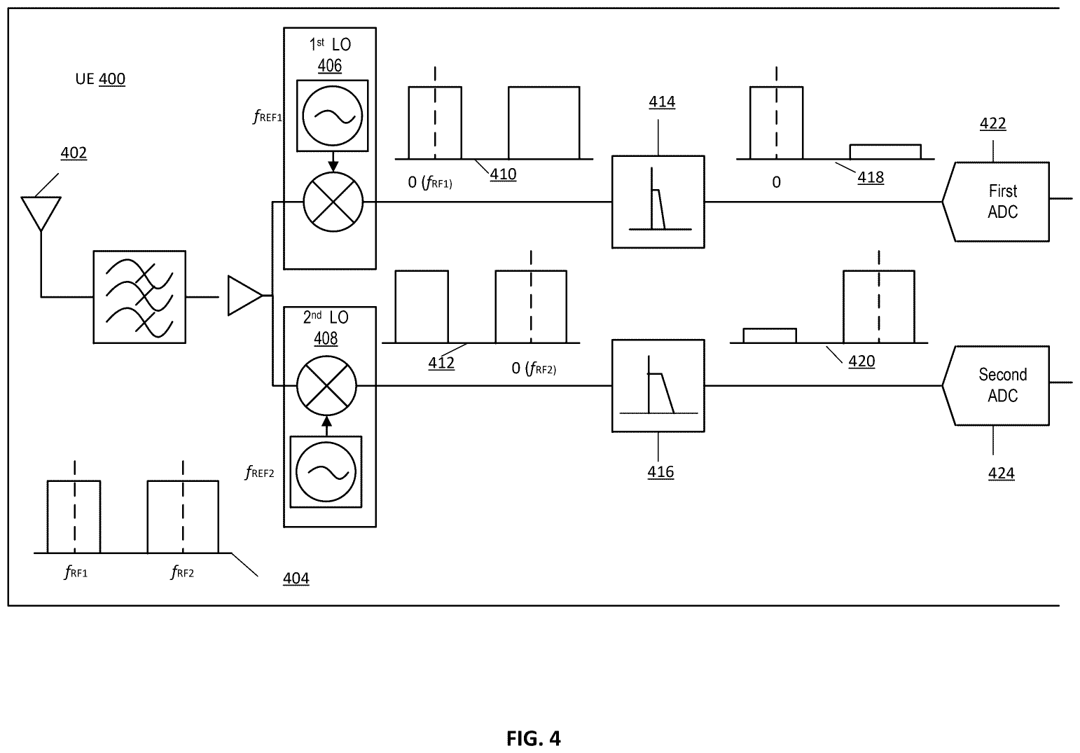

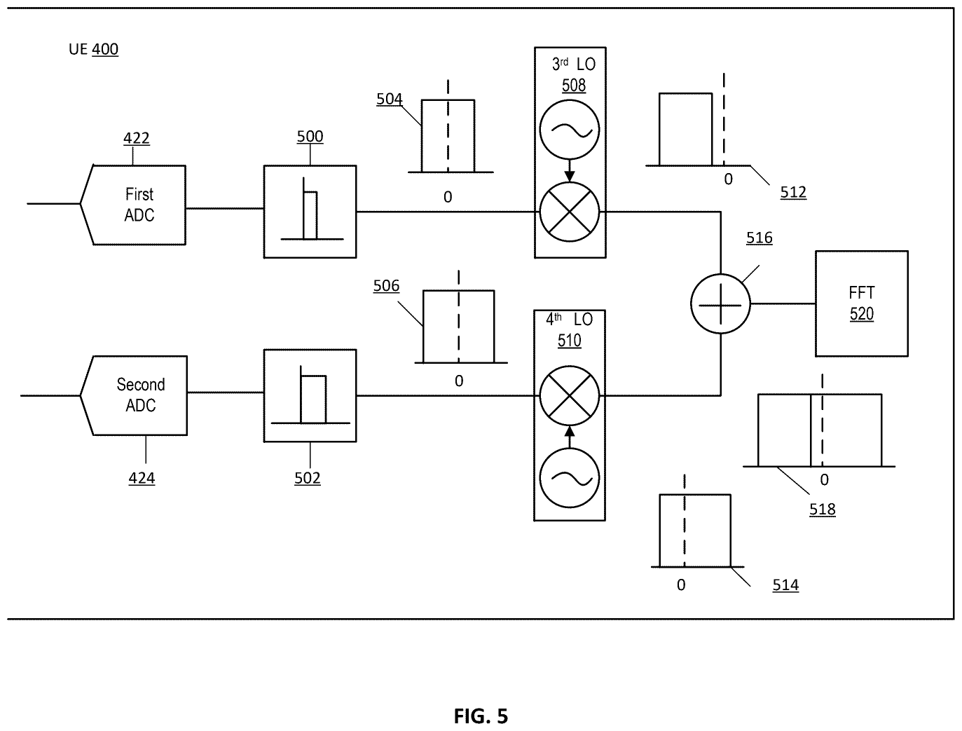

FIGS. 2-5 describe circuit diagrams that can be used to remove an in-gap blocker 114 from between fragmented carriers, or reduce a width of a gap 118 between fragmented carriers. FIGS. 2 and 3 are an illustration of processing circuitry of a UE 200 (e.g., UE 106), where FIG. 3 is a continuation of FIG. 2. FIGS. 4 and 5 are an illustration of processing circuitry of a UE 400 (e.g., UE 106), where FIG. 5 is a continuation of FIG. 4. The processing circuitry described by FIG. 2-5 can be used to combine two carriers into a single carrier having a tunable bandwidth that is less than a threshold bandwidth.

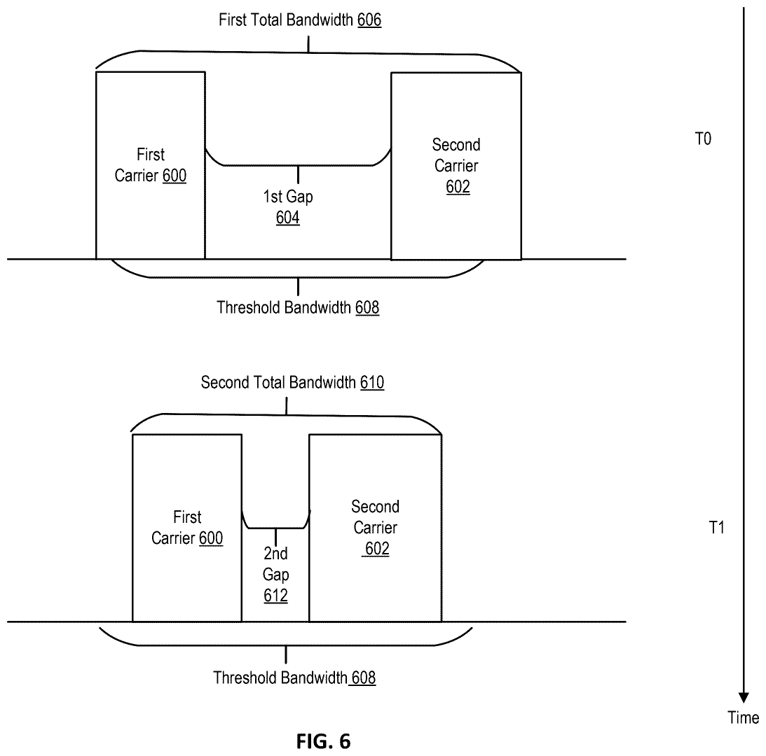

FIG. 2 is an illustration of processing circuitry for a UE 200, according to one or more embodiments. An antenna 202 can receive a DL transmission (e.g., DL transmission 104) such as an analog signal over a channel from a base station (e.g., base station 102). The DL transmission from the base station can include two or more fragmented carriers, in the form of an analog signal, in which fragmented carriers are separated by frequency gaps. As illustrated in a first representation 204, the fragmented carriers can be separated by a frequency gap between and centered around a reference frequency. For illustrative purposes it can be assumed that a total bandwidth of the fragmented carriers and the frequency gap exceed a threshold bandwidth. The total bandwidth can include the sum of a respective bandwidth of each fragmented carrier and the bandwidth of the frequency gap. The total bandwidth is described with more particularity with respect to FIG. 6. The threshold bandwidth can be established by the 3GPP technical standards, UE (e.g., UE 106) technical constraints, or other threshold parameter, such as a predefined rule or UE capability. It should be appreciated that the embodiments described herein can be used even if the total bandwidth of the fragmented carriers and the frequency gap did not exceed the threshold bandwidth.

To assist with demodulation of the DL transmission, the analog signal can be passed through a first local oscillator (LO) 206. The first LO 206 can include a signal generator for generating a signal at a desired frequency. As illustrated, the desired frequency can be the center frequency of the frequency gap. The first LO 206 can mix the generated signal with the fragmented carriers to convert the frequency of the fragmented carriers to an intermediate frequency (IF), which in this case can be the center frequency of the frequency gap. A second representation 208 of the output of the first LO 206 is provided in FIG. 2. As illustrated, the fragmented carriers are spaced apart and a frequency gap is between the fragmented carriers. It should be appreciated that in some instances, an in-gap blocker (e.g., in-gap blocker 114) can be present based on signal from a different operator as described with respect to FIG. 1 above. As further illustrated, one fragmented carrier can be considered to have a negative IF frequency. The other fragmented carrier can be considered to have a positive IF frequency. It should be appreciated that a negative frequency can be a mathematical construct used in the context of complex signals processing. In other words, the negative frequencies are not true negative frequencies, rather they are a mathematical representation in the frequency domain.

The output of the first LO 206 can be transmitted to a first bandpass IF filter 210 and a second bandpass IF filter 212. Each of the first bandpass IF filter 210 and the second bandpass IF filter 212 can be a complex bandpass filter that is configured to pass a range of frequencies and reject frequencies that are outside of a range. The frequency range can include the frequency ranges of the fragmented carriers. The first bandpass IF filter 210 can be a high pass filter that passes signals above a first cut-off frequency and attenuates signals below the first cut-off frequency. A third representation 214 of the output of the first bandpass IF filter 210 is provided in FIG. 2. As illustrated, the first bandpass IF filter 210 can pass the frequency above the first cut-off frequency, while attenuating signals below the first cut-off frequency.

The second bandpass IF filter 212 can be a low pass filter that passes signals below a second cut-off frequency and attenuate signals above the second cut-off frequency. A fourth representation 216 of the output of the second bandpass IF filter 212 is provided in FIG. 2. As illustrated, the second IF filter 212 can pass the frequency below the second cut-off frequency, while attenuating signals above the second cut-off frequency. In the event that the frequency gap includes an in-gap blocker, passing the signals through the first bandpass IF filter 210 and the second bandpass IF filter 212 can attenuate the in-gap blocker. As illustrated in FIG. 1, the frequency range of the in-gap blocker 114 can begin below the first cut-off frequency and end above the second cut-off frequency. Therefore, as a signal passes through a bandpass IF filter, the frequencies associated with the in-gap blocker can be attenuated to remove the in-gap blocker. The output of the first bandpass IF filter 210 can be transmitted to a first analog-to-digital converter (ADC). The output of the second bandpass IF filter 212 can be transmitted to a second ADC 220.

FIG. 3 is an illustration of processing circuitry for a UE 200, according to one or more embodiments. As indicated above, FIG. 3 is a continuation of FIG. 2. Each ADC can convert an analog signal received from a respective IF filter into a digital signal. For example, an ADC (e.g., first ADC 218, second ADC 220) can sample an analog signal received from a respective IF filter (e.g., first bandpass IF filter 210, second bandpass IF filter 212). The ADC can further quantize the sampled analog values into discrete values. The ADC can then encode the discrete values into a binary format to generate the digital signal.

The first ADC 218 can transmit an output to a first digital bandpass IF filter 300. The second ADC 220 can transmit an output to a second digital bandpass IF filter 302. Each of the first digital bandpass IF filter 300 and the second digital bandpass IF filter 302 can be a tunable digital complex bandpass filter, where a complex bandpass filter can be a filter that processes two signals denoted by real and imaginary components. As opposed to a fixed frequency LO, which produces a single frequency, a tunable LO can produce a different frequencies within a range. The first digital bandpass IF filter 300 can be a high pass filter that passes digital signals above a third cut-off frequency and attenuates signals below the third cut-off frequency. A fifth representation 304 of the output of the first digital bandpass IF filter 300 is provided in FIG. 3. As illustrated, the first digital bandpass IF filter 300 passes a digital signal above the third cut-off frequency, which is a positive frequency that is greater than the center frequency of the frequency gap.

The second digital bandpass IF filter 302 can be a low pass filter that passes digital signals below a fourth cut-off frequency and attenuates signals above the fourth cut-off frequency. A sixth representation 306 of the output of the fourth bandpass IF filter 302 is provided in FIG. 3. As illustrated, the second digital bandpass IF filter 302 passes a digital signal below the fourth cut-off frequency, which is a negative frequency that is less than the center frequency of the frequency gap.

The first digital bandpass IF filter 300 can transmit an output to a second LO 308 and the second digital bandpass IF filter 302 can transmit an output to the third LO 310. The second LO 308 can perform a digital down-conversion to shift the high frequency digital signal from the third bandpass IF filter 300 to a lower frequency. The incoming output from the third bandpass IF filter 300 can be multiplied by an exponential value that is based on a frequency of the second LO 308. This operation can shift the digital signal's frequency range toward the center frequency, or some other desired frequency. In some instances, the signal can be passed through another bandpass filter to remove any undesired frequencies. A seventh representation 312 of an output of the second LO 308 is provided in FIG. 3. As illustrated the second LO 308 has generated a digital signal that is adjacent to the center frequency of 0 Hz. This effectively removes any portion of a frequency gap that was above the center frequency.

The third LO 310 can perform a digital up-conversion to shift the low frequency digital signal from the second bandpass IF filter 302 to a higher frequency. The incoming output from the second bandpass IF filter 302 can be multiplied by an exponential value that is based on a frequency of the third LO 310. This operation can shift the digital signal's frequency up toward the center frequency, or some other desired frequency. In some instances, the signal can be passed through another bandpass filter to remove any undesired frequencies. An eighth representation 314 of an output of the third LO 310 is provided in FIG. 3. As illustrated the third LO 310 has generated a signal that is adjacent to the center frequency of 0 Hz. In other words, the signal has an ending frequency of at the center frequency.

The second LO 308 and the third LO 310 can transmit their respective outputs to an adder 316, which can be configured to add the shifted signals into a single carrier. A ninth representation 318 of the signals is provided in FIG. 3. It should be appreciated that the UE 200 can configure the digital down-conversions and digital up-conversions, such that the outputs of the second LO 308 and the third LO 310 can be orthogonal to each other. This orthogonality can be achieved by causing a desired frequency spacing between the carrier signals. For example, the carrier from the second LO 308 can be multiple sub-carrier spacings (SCSs) apart from carrier signal from the third LO 310.

The single carrier can be a combined digital signal that has a total bandwidth that is less than the threshold bandwidth. For example, if the fragmented segments include frequencies that are allocated for frequency division duplexing (FDD) bands, the total bandwidth of the shifted signals can be less than 50 MHz. In another example, if the fragmented segments include frequencies that are allocated for time division duplexing (TDD) bands, the total bandwidth of the shifted signals can be less than 100 MHz. A ninth representation 318 of an output of the adder 316 is provided in FIG. 3. As illustrated, the signals have been shifted by the second LO 308 and the third LO 310, such that there is no frequency gap as illustrated with respect to the first representation, in which a frequency gap separates a first carrier from a second carrier. It should be appreciated that the individual bandwidths of the fragmented segments has not changed, rather the bandwidth occupied by the frequency gap has been reduced.

As illustrated, shifting the signals have removed the frequency gap. It should be appreciated that is some instances, the digital signal generated by the second LO 308 may not have a starting frequency at the center frequency, or the digital signal generated by the third LO 310 may not have an ending frequency at the center frequency. In these instances, there still may be a frequency gap with a reduced bandwidth between the signals. However, even with the spectrum with the reduced bandwidth gap, the total bandwidth of the shifted signals and the frequency gap can be less than the threshold bandwidth.

The output of the adder 316 can be transmitted to a fast Fourier transform (FFT) unit 320 to process the signal as a single carrier. It should be appreciated that the bandwidth of the signal outputted by the adder 316 can be less than the threshold bandwidth. Had the bandwidth been greater than the threshold bandwidth, the FFT unit 320 may have not been able to process the signal properly. For example, there may have been a lack of fidelity between the information received by the antenna 202 and the information outputted by the FFT unit 320.

FIG. 4 is an illustration of processing circuitry for a UE 400, according to one or more embodiments. The processing circuitry can be used to combine two carriers into a single carrier having a tunable bandwidth that is less than a threshold bandwidth. An antenna 402 can receive a DL transmission (e.g., DL transmission 104) from a base station (e.g., base station 102). The DL transmission from the base station can include two or more fragmented carriers, such as a first fragmented carrier and a second fragmented carrier, in the form of an analog signal. A tenth representation 404 of the fragmented carriers is provided in FIG. 4. Each of the first fragmented carrier and the second fragmented carrier can have a different bandwidth. In some embodiments, the first fragmented carrier can have a lower frequency range than the second fragmented carrier. As illustrated, the fragmented carriers can be separated by a frequency gap. For illustrative purposes it can be assumed that an aggregated bandwidth of the fragmented carriers and the frequency gap exceed a threshold bandwidth. The aggregated bandwidth can include the sum of respective bandwidth of each fragmented carrier and the bandwidth of the frequency gap.

The analog signal can be passed through a first LO 406 and a second LO 408 . . . . The first LO 406 can mix a generated signal with the first fragmented carrier to convert the frequency to a first IF, which can be the center frequency of the first fragmented carrier. An eleventh representation 410 of the output of the first LO 406 is provided in FIG. 4. As illustrated a first fragmented carrier can have a center frequency of 0 Hz. The second LO 408 can mix a generated signal with the second fragmented carrier to convert the frequency of to a second IF, which can be the center frequency of the second fragmented carrier. A twelfth representation 412 of the output of the second LO 408 is provided in FIG. 4. As illustrated, a second fragmented carrier can have a center frequency of 0 Hz.

The output of the first LO 406 can be transmitted to a first tunable lowpass filter 414 and the output of the second LO 408 can be transmitted to a second tunable lowpass filter 416. The first tunable lowpass filter 414 can passe a signal below a first cut-off frequency and attenuates signals above the first cut-off frequency. A thirteenth representation 418 of the output of the first tunable lowpass filter 414 is provided in FIG. 4. As illustrated, the first tunable lowpass filter 414 can pass the frequency below the first cut-off frequency (e.g., the first fragmented carrier), while attenuating signals above the cut-off frequency.

The second tunable lowpass filter 416 can pass signals below a second cut-off frequency and attenuate signals above the second cut-off frequency. A fourteenth representation 420 of the output of the second tunable lowpass filter 416 is provided in FIG. 4. As illustrated, the second tunable lowpass filter 416 can pass the frequency below the second cut-off frequency, while attenuating signals above the cut-off frequency. In the event that the frequency gap includes an in-gap blocker, passing the signals through the first tunable lowpass filter 414 and the second tunable lowpass filter 416 can attenuate the in-gap blocker. The output of the first tunable lowpass filter 414 can be transmitted to a first ADC 422. The output of the second tunable lowpass filter 416 can be transmitted to a second ADC 424.

FIG. 5 is an illustration of processing circuitry for a UE 400, according to one or more embodiments. As indicated above, FIG. 5 is a continuation of FIG. 4. Each ADC can convert an analog signal received from a respective tunable filter into a digital signal. For example, an ADC (e.g., first ADC 422, second ADC 424) can sample an analog signal received from a respective tunable filter (e.g., first tunable lowpass filter 414, second unable lowpass filter 416). The ADC can further quantize the sampled analog values into discrete values. The ADC can then encode the discrete values into a binary format to generate the digital signal.

The first ADC 422 can transmit an output to a first tunable digital low pass filter 500. The second ADC 424 can transmit an output to a second tunable digital low pass filter 502. The first tunable digital low pass filter 500 can pass digital signals below a third cut-off frequency and attenuate digital signals above the third cut-off frequency. A fifteenth representation 504 of the output of the first tunable digital low pass filter 500 is provided in FIG. 5. As illustrated, the first tunable digital low pass filter 500 passes a digital signal below the third cut-off frequency.

The first tunable digital low pass filter 502 can pass digital signals above a fourth cut-off frequency and attenuate signals above the fourth cut-off frequency. A sixteenth representation 506 of the output of the second tunable digital low pass filter 502 is provided in FIG. 5. As illustrated, the second tunable digital low pass filter 502 passes a digital signal below the fourth cut-off frequency. As illustrated by the thirteenth representation 504 and the fourteenth representation 506 each of the frequency ranges outputted by the filters can be centered at the center frequencies of the respective fragmented carriers.

The first tunable digital low pass filter 500 can transmit an output to a third LO 508 and the second tunable digital high pass filter 502 can transmit an output to the fourth LO 510. The third LO 508 can perform a digital down-conversion to shift the high frequency digital signal to a lower frequency. The incoming output from the first tunable digital low pass filter 500 can be multiplied by an exponential value that is based on a frequency of the third LO 508. This operation can shift the digital signal's frequency range down below the center frequency. As illustrated, the shift can leave a gap between the frequency range and the center frequency. In some instances, the signal can be passed through another bandpass filter to remove any undesired frequencies. A seventeenth representation 512 of an output of the third LO 508 is provided in FIG. 5. As illustrated the third LO 508 has generated a digital signal that no longer includes the center frequency, and a frequency gap is present between the digital signal and the center frequency.

The fourth LO 510 can perform a digital up-conversion to shift the low frequency digital signal from the second tunable digital low pass filter 502 to a higher frequency. The incoming output from the second tunable digital low pass filter 502 can be multiplied by an exponential value that is based on a frequency of the fourth LO 510. This operation can shift the digital signal's frequency up from the center frequency of 0 Hz. In some instances, the signal can be passed through another bandpass filter to remove any undesired frequencies. An eighteenth representation 514 of an output of the fourth LO 510 is provided in FIG. 5. As illustrated the fourth LO 510 has generated a signal that includes a frequency range that is no longer centered at the center frequency. A portion of the digital signal lies below the center frequency. The UE 400 can configure the width of this portion to be equal to or less than the width of the frequency gap created by the third LO 508. Another portion of the digital signal lies above the center frequency.

The third LO 508 and the fourth LO 510 can transmit their respective outputs to an adder 516, which can be configured to add the shifted signals into a single carrier. It should be appreciated that after the digital down-conversions, the carrier signals outputted by the third LO 508 and the fourth LO 510 to form the single carrier signal, such as a combined digital signal, that can be orthogonal to each other. This orthogonality can be achieved by the UE 400 by causing a desired frequency spacing between the carrier signals For example, the carrier from the third LO 508 can be multiple SCSs apart from carrier signal from the fourth LO 510.

The single carrier can have a bandwidth that is less than the threshold bandwidth. For example, if the fragmented segments include frequencies that are allocated for FDD bands, the aggregated bandwidth of the shifted signals can be less than 50 MHz. In another example, if the fragmented segments include frequencies that are allocated for frequency for TDD bands, the aggregated bandwidth of the shifted signals can be less than 100 MHz.

A nineteenth representation 518 of an output of the adder 238 is provided in FIG. 5. As illustrated, the signals have been shifted by the third LO 508 and the fourth LO 510, such that there is no frequency gap as illustrated with respect to the first representation, in which a frequency gap separates a first carrier from a second carrier. It should be appreciated that in some instances can gap can present between the carriers as long as the total bandwidth of the carriers and any gap is less than the threshold bandwidth.

The output of the adder 516 can be transmitted a FFT unit 520 to process the signal as a single carrier. It should be appreciated that the bandwidth of the signal outputted by the adder 516 can be less than the threshold bandwidth. Had the bandwidth been greater than the threshold bandwidth, the FFT unit 520 may have not been able to process the signal properly. For example, there may have been a lack of fidelity between the information received by the antenna 402 and the information outputted by the FFT unit 520.

FIG. 6 is an illustration of a reduction in total bandwidth, according to one or more embodiments. As illustrated a first carrier 600 (e.g., CC1 110) and a second carrier 602 (CC2 112) can be fragmented carriers that are separated by a first gap 604 (e.g., frequency gap 118). As illustrated, the first total bandwidth 606 can be the width of the first carrier 600 plus the width of the gap 604 plus a width of the second carrier. Furthermore, the width of the first total bandwidth 606 can be greater than a threshold bandwidth 608 (e.g., maximum FR 1 CBW 116). The embodiment described above can be used to reduce the total bandwidth from the first total bandwidth 606 to the second total bandwidth, where the second total bandwidth 610 is less than the first total bandwidth 606. The second total bandwidth can further be less than the threshold bandwidth 608.

As further illustrated, the width of the first carrier and the width of the second carrier 602 may not have been reduced. Rather the embodiments herein can be used to shift the carriers toward each other. This can reduce the width of the first gap 604 to a smaller width of a second gap 612. It should be appreciated that in some embodiments, the first carrier 600 and the second carrier 602 are shifted to completely eliminate the first gap 604, such that there is no gap. between the carriers.

As further indicated above, in some instances, an in-gap blocker (e.g., in-gap blocker 114) is located at the first gap 604. The embodiments herein can be used to remove the in-gap blocker, such that the processing circuitry of the UE (e.g., UE 106) can process the first carrier 600 and the second carrier 602 without processing an in-gap blocker.

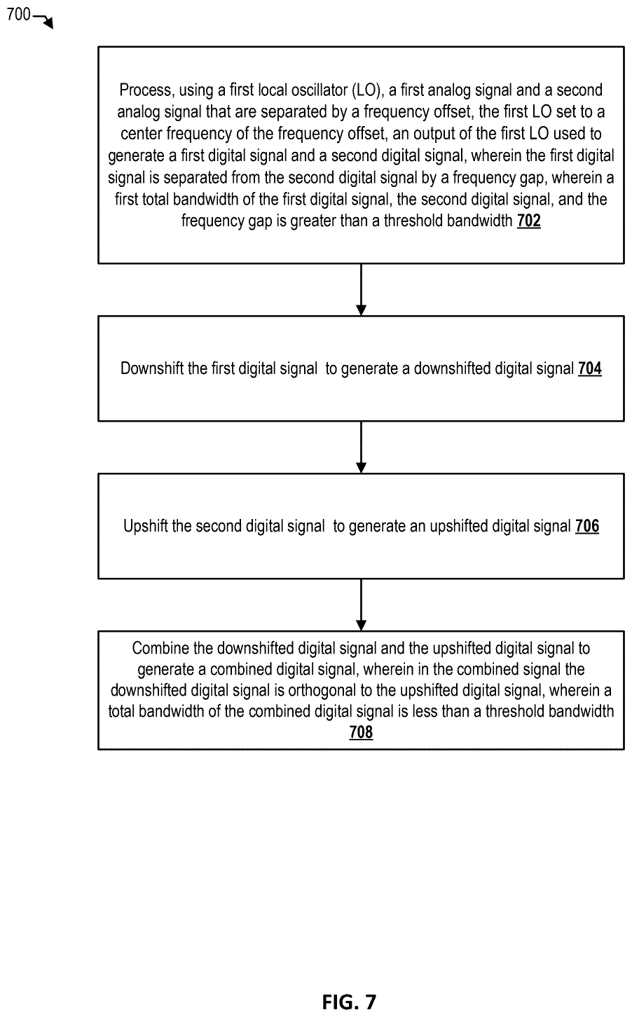

FIG. 7 is a process 700 for combining fragmented carriers, according to one or more embodiments. At 702, the process can include an apparatus of a UE (e.g., UE 106) processing, using a first local oscillator (LO), a first analog signal and a second analog signal that are separated by a frequency gap. For example, the apparatus can process a DL transmission from a base station (e.g., base station 102) that includes the analog signals, such as two fragmented carriers. The first LO (e.g., first LO 206) can be set to a center frequency of the frequency gap. An output of the first LO can be used to generate a first digital signal and a second digital signal, where the first digital signal is separated from the second digital signal by the frequency gap. A first total bandwidth (e.g., first total bandwidth 606) of the first digital signal, the second digital signal, and the frequency gap can greater than a threshold bandwidth (e.g., threshold bandwidth 608). The first analog signal and the second analog signal can represent information.

At 704, the process 700 can include the apparatus downshifting the first digital signal based on the center frequency to generate a downshifted digital signal. For example, the apparatus can generate a digital signal using a first bandpass IF filter (e.g. first bandpass IF filter 210) and a first ADC (e.g., first ADC 218) to generate a digital signal. The apparatus can further use a first digital bandpass IF filter (e.g., first digital bandpass IF filter 300) and a second LO (e.g., second LO 308) to downshift the digital signal.

At 706, the process 700 can include the apparatus upshifting the second digital signal based on the center frequency to generate an upshifted digital signal. For example, the apparatus can generate a digital signal using a second bandpass filter (e.g. second bandpass filter 212) and a second ADC (e.g., second ADC 220) to generate a digital signal. The apparatus can further use a second digital bandpass IF filter (e.g., second digital bandpass IF filter 302) and a third LO (e.g., third LO 310) to upshift the digital signal.

At 708, the process 700 can include the apparatus combining the downshifted signal and the upshifted signal to generate a combined digital signal. The downshifted digital signal can be orthogonal to the upshifted digital signal to prevent the signals from overlapping, A second total bandwidth (e.g., second total bandwidth 610) of the combined digital signal is less than the threshold bandwidth. For example, the UE, can use an adder (e.g., adder 316) to combine the digital signals to generate the combined digital signal.

The apparatus process the combined digital signal to determine the information. For example, the apparatus can cause the combined digital signal to be transmitted to an FFT unit (e.g., FFT unit 320) for further processing to determine the information.

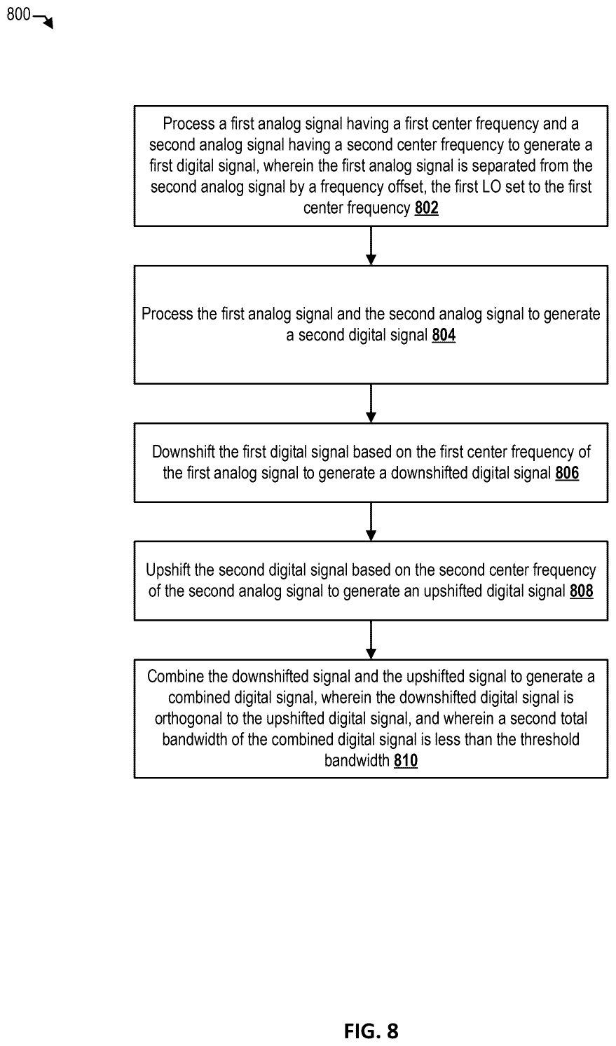

FIG. 8 is a process 800 for combining fragmented carriers, according to one or more embodiments. At 802, the process 800 can include an apparatus processing, using a first LO (e.g., first LO 406), a first analog signal and a second analog signal, where the first analog signal and the second analog signal are separated by a frequency offset. For example, the apparatus can process a DL transmission from a base station (e.g., base station 102) that includes the analog signals, such as two fragmented carriers. The first LO can be set to a first center frequency of the first analog signal. The first analog signal and the second analog signal can represent information.

At 804, the process 800 can include the apparatus processing, using a second LO (e.g., second LO 408), the first analog signal and the second analog signal. The second LO can be set to a second center frequency of the second analog signal. A first output of the first LO can be used to generate a first digital signal and a second output of the second LO can be used to generate a second digital signal. The first digital signal can be separated from the second digital signal by the frequency gap. A first total bandwidth (e.g., first total bandwidth 606) of the first digital signal, the second digital signal, and the frequency gap is greater than a threshold bandwidth (e.g., threshold bandwidth 608).

At 806, the process 800 can include the apparatus downshifting the first digital signal based on the first center frequency of the first analog signal to generate a downshifted digital signal. For example, the apparatus can generate a digital signal using a first tunable lowpass filter (e.g. first tunable lowpass filter 414) and a first ADC (e.g., first ADC 422) to generate a digital signal. The apparatus can further use a first tunable digital low pass filter (e.g., first tunable digital low pass filter 500) and a third LO (e.g., third LO 508) to downshift the digital signal.

At 808, the process 800 can include the apparatus upshifting the second digital signal based on the second center frequency of the second analog signal to generate an upshifted digital signal. For example, the apparatus can generate a digital signal using a second tunable lowpass filter (e.g. second tunable lowpass filter 416) and a second ADC (e.g., second ADC 424) to generate a digital signal. The apparatus can further use a second tunable digital low pass filter (e.g., second tunable digital low pass filter 502) and a third LO (e.g., fourth LO 510) to upshift the digital signal.

At 810, the process can include the apparatus combining the downshifted signal and the upshifted signal to generate a combined digital signal, wherein the downshifted digital signal is orthogonal to the upshifted digital signal. A second total bandwidth (e.g., second total bandwidth 610) of the combined digital signal is less than the threshold bandwidth. For example, the UE, can use an adder (e.g., adder 516) to combine the digital signals to generate the combined digital signal.

The apparatus process the combined digital signal to determine the information. For example, the apparatus can cause the combined digital signal to be transmitted to an FFT unit (e.g., FFT unit 320) for further processing to determine the information.

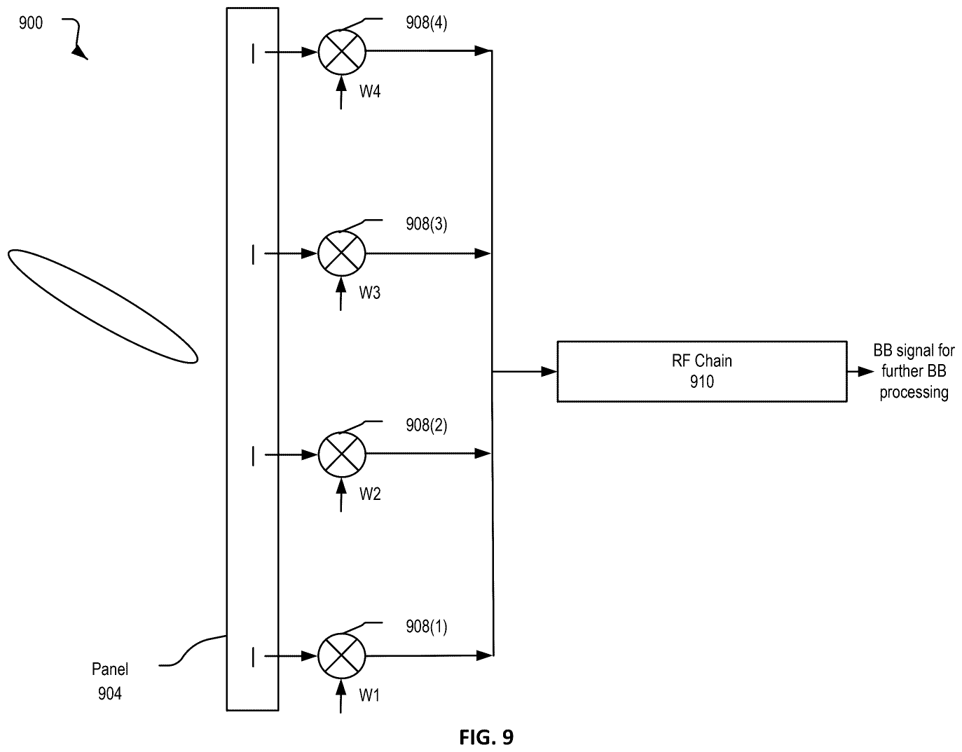

FIG. 9 illustrates receive components 900 of the UE 906, in accordance with some embodiments. The receive components 900 may include an antenna panel 904 that includes a number of antenna elements. The panel 904 is shown with four antenna elements, but other embodiments may include other numbers.

The antenna panel 904 may be coupled to analog beamforming (BF) components that include a number of phase shifters 908(1)-908(4). The phase shifters 908(1)-908(4) may be coupled with a radio-frequency (RF) chain 913. The RF chain 913 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 908(1)-908(4) to provide a receive beam at the antenna panel 904. These BF weights may be determined based on the channel-based beamforming. In some embodiments, the control circuitry may be used to process fragmented carriers.

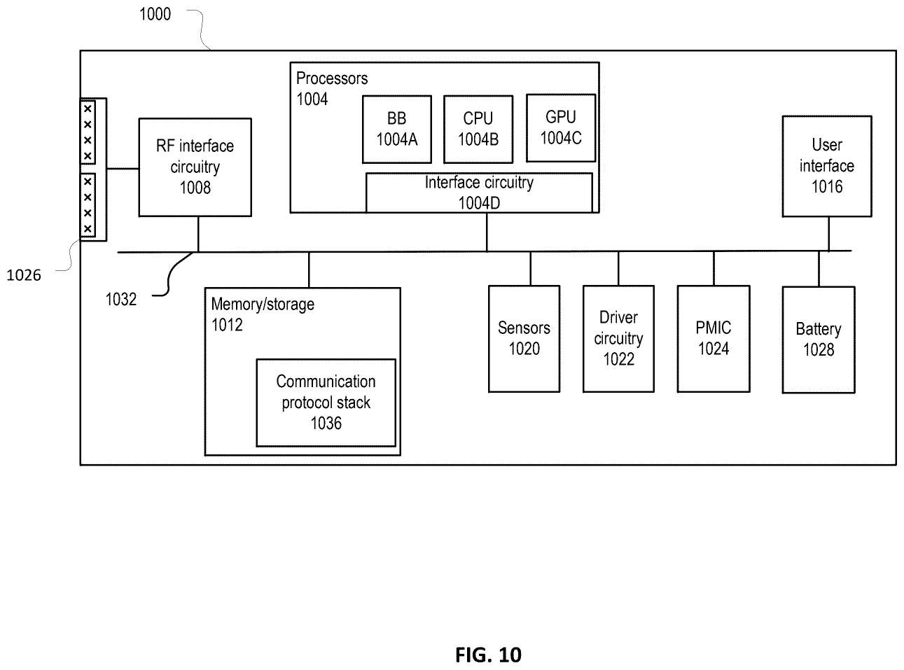

FIG. 10 illustrates a UE 1000, in accordance with some embodiments. The UE 1000 may be similar to and substantially interchangeable with UE 106 of FIG. 1. The UE 1000 can perform any of the functionality described herein. For example, the UE can be configured to broadcast configuration parameters. The UE 1000 can be configured to decode a message received via a broadcast channel, where message includes configuration parameters of another UE.

The processors 1004 may include processor circuitry such as, for example, baseband processor circuitry (BB) 1004A, central processor unit circuitry (CPU) 1004B, and graphics processor unit circuitry (GPU) 1004C. The processors 1004 may include any type of circuitry or processor circuitry that executes or otherwise operates computer-executable instructions, such as program code, software modules, or functional processes from memory/storage 1012 to cause the UE 1000 to perform delay-adaptive operations as described herein. The processors 1004 may also include interface circuitry 1004D to communicatively couple the processor circuitry with one or more other components of the UE 1000.

In some embodiments, the baseband processor circuitry 1004A may access a communication protocol stack 1036 in the memory/storage 1012 to communicate over a 3GPP compatible network. In general, the baseband processor circuitry 1004A may access the communication protocol stack 1036 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1008.

The baseband processor circuitry 1004A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink. In some embodiments, the control circuitry may be used to upshift or downshift a fragments carrier to reduce a frequency gap that is surrounded by the carriers.

The memory/storage 1012 may include one or more non-transitory, computer-readable media that includes instructions (for example, communication protocol stack 1036) that may be executed by one or more of the processors 1004 to cause the UE 1000 to perform various delay-adaptive operations described herein.

The memory/storage 1012 includes any type of volatile or non-volatile memory that may be distributed throughout the UE 1000. In some embodiments, some of the memory/storage 1012 may be located on the processors 1004 themselves (for example, memory/storage 1012 may be part of a chipset that corresponds to the baseband processor circuitry 1004A), while other memory/storage 1012 is external to the processors 1004 but accessible thereto via a memory interface. The memory/storage 1012 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1008 may include transceiver circuitry and a radio frequency front module (RFEM) that allows the UE 1000 to communicate with other devices over a radio access network. The RF interface circuitry 1008 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1026 and proceed to filter and amplify (with a low-noise amplifier) the signal. The signal may be provided to a receiver of the transceiver that down-converts the RF signal into a baseband signal that is provided to the baseband processor of the processors 1004.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1026.

In various embodiments, the RF interface circuitry 1008 may be configured to transmit/receive signals in a manner compatible with NR access technologies.

The antenna 1026 may include antenna elements to convert electrical signals into radio waves to travel through the air and to convert received radio waves into electrical signals. The antenna elements may be arranged into one or more antenna panels. The antenna 1026 may have antenna panels that are omnidirectional, directional, or a combination thereof to enable beamforming and multiple input, multiple output communications. The antenna 1026 may include microstrip antennas, printed antennas fabricated on the surface of one or more printed circuit boards, patch antennas, or phased array antennas. The antenna 1026 may have one or more panels designed for specific frequency bands including bands in FR1 or FR2.

The user interface 1016 includes various input/output (I/O) devices designed to enable user interaction with the UE 1000. The user interface 1016 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1000.

The sensors 1020 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1022 may include software and hardware elements that operate to control particular devices that are embedded in the UE 1000, attached to the UE 1000, or otherwise communicatively coupled with the UE 1000. The driver circuitry 1022 may include individual drivers allowing other components to interact with or control various input/output (I/O) devices that may be present within, or connected to, the UE 1000. For example, driver circuitry 1022 may include a display driver to control and allow access to a display device, a touchscreen driver to control and allow access to a touchscreen interface, sensor drivers to obtain sensor readings of sensors 1020 and control and allow access to sensors 1020, drivers to obtain actuator positions of electro-mechanic components or control and allow access to the electro-mechanic components, a camera driver to control and allow access to an embedded image capture device, audio drivers to control and allow access to one or more audio devices.

The PMIC 1024 may manage power provided to various components of the UE 1000. In particular, with respect to the processors 1004, the PMIC 1024 may control power-source selection, voltage scaling, battery charging, or DC-to-DC conversion.

A battery 1028 may power the UE 1000, although in some examples the UE 1000 may be mounted deployed in a fixed location and may have a power supply coupled to an electrical grid. The battery 1028 may be a lithium ion battery, a metal-air battery, such as a zinc-air battery, an aluminum-air battery, a lithium-air battery, and the like. In some implementations, such as in vehicle-based applications, the battery 1028 may be a typical lead-acid automotive battery.

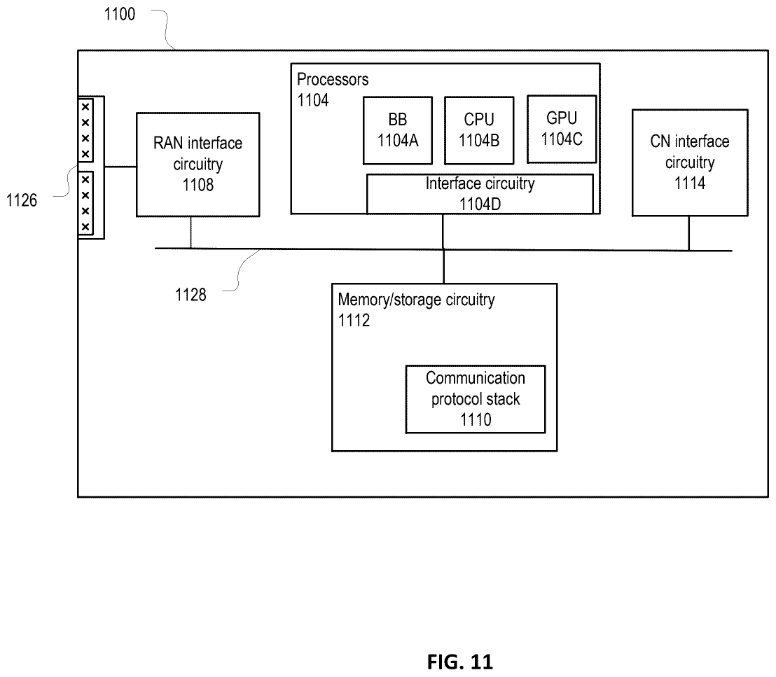

FIG. 11 illustrates a network device 1100 in accordance with some embodiments. The network device 1000 may be similar to and substantially interchangeable with base station or a device of the core network or external data network. The network device 1100 can be configured to receive a HO request from a UE (e.g., UE 1000). The network device 1100 can further be configured to determine whether resource can be allocated to the UE to satisfy the HO request. The network device 1100 can further transmit configuration information to UE in response to the HO request.

The network device 1100 may include processors 1104, RF interface circuitry 1108 (if implemented as a base station), core network (CN) interface circuitry 1114, memory/storage circuitry 1112, and antenna structure 1126.

The components of the network device 1100 may be coupled with various other components over one or more interconnects 1128.

The processors 1104, RF interface circuitry 1108, memory/storage circuitry 1112 (including communication protocol stack 1110), antenna structure 1126, and interconnects 1128 may be similar to like-named elements shown and described with respect to FIG. 10.

The processors 1104 may include processor circuitry such as, for example, baseband processor circuitry (BB) 1104A, central processor unit circuitry (CPU) 1104B, and graphics processor unit circuitry (GPU) 1104C. The processors 1104 may include any type of circuitry or processor circuitry that executes or otherwise operates computer-executable instructions, such as program code, software modules, or functional processes from memory/storage circuitry 1112 to cause the UE to perform delay-adaptive operations as described herein. The processors 1104 may also include interface circuitry 1004D to communicatively couple the processor circuitry with one or more other components of the network device 1100. In some embodiments, the processors 1104 may be used to cause the transmission of fragmented carriers to a UE.

The CN interface circuitry 1114 may provide connectivity to a core network, for example, a 5th Generation Core network (5GC) using a 5GC-compatible network interface protocol such as carrier Ethernet protocols, or some other suitable protocol. Network connectivity may be provided to/from the network device 1100 via a fiber optic or wireless backhaul. The CN interface circuitry 1114 may include one or more dedicated processors or FPGAs to communicate using one or more of the aforementioned protocols. In some implementations, the CN interface circuitry 1114 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

[In the following sections, further example embodiments are provided. [examples to be updated upon approval of the claims]

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a first analog signal and a second analog signal that are separated by a frequency offset to generate a first digital signal and a second digital signal, wherein the first digital signal is separated from the second digital signal by a frequency gap, wherein a first total bandwidth of the first digital signal, the second digital signal, and the frequency gap is greater than a threshold bandwidth;
downshifting the first digital signal based on the center frequency to generate a downshifted digital signal;
upshifting the second digital signal based on the center frequency to generate an upshifted digital signal; and
combining the downshifted digital signal and the upshifted digital signal to generate a combined digital signal, wherein the downshifted digital signal is orthogonal to the upshifted digital signal, and wherein a second total bandwidth of the combined digital signal is less than a threshold bandwidth.

2. The method of claim 1, wherein downshifting the first digital signal reduces a first portion of the frequency gap, wherein upshifting the second digital signal reduces a second portion of the frequency gap, wherein a third portion of the frequency gap remains after the upshifting and the downshifting, and wherein the second total bandwidth comprises a width of the third portion of the frequency gap.

3. The method of claim 1, wherein downshifting the first digital signal and upshifting the second digital signal causes the downshifted digital signal to be adjacent to the upshifted digital signal, and wherein the second total bandwidth does not comprise a width of the frequency gap.

4. The method of claim 1, wherein the method further comprises:
processing, using a first tunable digital intermediate frequency (IF) bandpass filter, the first digital signal to attenuate a third portion of the first digital signal that is lower than a first cut-off frequency; and
processing, using a second tunable digital IF bandpass filter, the second digital signal to attenuate a fourth portion of the second digital signal that is above a second cut-off frequency, wherein the combined digital signal comprises a fifth portion of the first digital signal that is above the first cut-off frequency and a sixth portion of the second digital signal that is below the second cut-off frequency.

5. The method of claim 1, wherein the threshold bandwidth is 50 MHz for a frequency division duplexing (FDD) band.

6. The method of claim 1, wherein the threshold bandwidth is 100 MHz for a time division duplexing (TDD) band.

7. The method of claim 1, wherein prior to processing the first digital signal and a second digital signal the method further comprises:
determining whether a third total bandwidth of the first analog signal, the second analog signal, and the frequency offset is greater than the threshold bandwidth; and
determining to reduce the frequency offset based on determining whether the third total bandwidth of the first analog signal, the second analog signal, and the frequency offset is greater than the threshold bandwidth, wherein the first analog signal is to be converted to the first digital signal, and wherein the second analog signal is to be converted to the second digital signal.

9. The method of claim 1, wherein the first analog signal and the second analog signal are processed by a local oscillator (LO), and wherein the method further comprises:
processing, using a first analog bandpass filter, an output of the LO to attenuate the second analog signal based on determining to reduce the frequency offset; and
processing, using a second analog bandpass filter, an output of the LO to attenuate the first analog signal based on determining to reduce the frequency offset.

10. The method of claim 9, wherein the first analog signal and the second analog signal are associated with a first network operator, and wherein the frequency offset comprises an in-gap blocker associated with a second network operator.

11. The method of claim 1, wherein combined digital signal is processed to determine information using a single fast Fourier transform (FFT).

12. The method of claim 1, wherein method further comprises:
determining that the second total bandwidth of the combined digital signal is less than the threshold bandwidth, wherein the combined digital signal is transmitted to a FFT unit to demodulate the combined digital signal based on determining that the second total bandwidth of the combined digital signal is less than the threshold bandwidth.

13. The method of claim 1, wherein the LO is a first LO, and wherein downshifting the first digital signal comprises using a second LO to shift a first frequency range toward reference frequency, and wherein upshifting the second digital signal comprises using a third LO to shift a second frequency range toward a reference signal.

14. The method of claim 1, wherein the threshold bandwidth is based on an analog-to-digital convertor (ADC) capability of a user equipment (UE) or a predefined rule.

15. An apparatus comprising:
processing circuitry configured to:
process, using a first local oscillator (LO), a first analog signal and a second analog signal to generate first digital signal and a second digital signal to a reference frequency of the first LO, wherein the first analog signal and the second analog signal are separated by a frequency offset that comprises the reference frequency, and wherein the first digital signal and the second digital signal are separated by a frequency gap, wherein the first digital signal comprises a positive intermediate (IF) frequency, and wherein the second digital signal comprises a negative IF frequency;
downshift, using a second LO, the first digital signal based on the reference frequency to generate a downshifted digital signal,
upshift, using a third LO, the second digital signal based on the reference frequency to generate an upshifted digital signal, and
combine, using an adder, the downshifted digital signal and upshifted digital signal to generate a combined digital signal, wherein the downshifted digital signal is orthogonal to the upshifted digital signal; and
memory coupled to the processing circuitry, the memory configured to store signal information.

16. The apparatus of claim 15, wherein the processing circuitry is further configured to:
determine that a first total bandwidth of the first digital signal, the second digital signal, and the frequency gap is greater than a threshold bandwidth, wherein the first digital signal and the first digital signal are processed based on determining that the first total bandwidth of the first digital signal, the second digital signal, and the frequency gap is greater than the threshold bandwidth.

17. The apparatus of claim 15, wherein the processing circuitry is further configured to:
determine that a second total bandwidth of the combined digital signal is less than a threshold bandwidth, wherein the combined digital signal is demodulated using an FFT to determine information represented by the combined digital signal based on determining that the second total bandwidth of the combined digital signal is less than the threshold bandwidth.

18. One or more non-transitory computer-readable media having stored thereon a sequence of instructions which, when executed by one or more processors, cause processing circuitry to:
determine whether a first total bandwidth of a first analog signal, a second analog signal, and a frequency offset separating the first analog signal and the second signal is greater than a threshold bandwidth;
process the first analog signal and the second analog signal to generate first digital signal and a second digital signal to a reference frequency, and wherein the first digital signal and the second digital signal are separated by the frequency gap, wherein the first digital signal comprises a positive intermediate (IF) frequency, and wherein the second digital signal comprises a negative IF frequency;
downshift the first digital signal based on the reference frequency to generate a downshifted digital signal based on determining whether the first total bandwidth of the first digital signal, the second digital signal, and the frequency gap separating the first digital signal and the second digital signal is greater than the threshold bandwidth;
upshift the second digital signal based on the reference frequency to generate an upshifted digital signal based on determining whether the first total bandwidth of the first digital signal, the second digital signal, and the frequency gap separating the first digital signal and the second digital signal is greater than the threshold bandwidth; and
combine the downshifted digital signal and upshifted digital signal to generate a combined digital signal, wherein the downshifted digital signal is orthogonal to the upshifted digital signal, and wherein a second total bandwidth of the combined digital signal is less than the threshold bandwidth.

19. The one or more non-transitory computer-readable media of claim 18, wherein the frequency gap is centered at a reference frequency, wherein downshifting the first digital signal reduces a first portion of the frequency gap between a first frequency range and the reference frequency, wherein upshifting the second digital signal reduces a second portion of the frequency gap between a second frequency range and the reference frequency, wherein a third portion of the frequency gap remains after the upshifting and the downshifting, and wherein the second total bandwidth comprises a width of the third portion of the frequency gap.

20. The one or more non-transitory computer-readable media of claim 18, wherein the sequence of instructions which, when executed by one or more processors, cause processing circuitry to:
determine that the second total bandwidth of the combined digital signal is less than the threshold bandwidth, wherein the combined digital signal is transmitted to an FFT unit to demodulate the combined digital signal based on determining that the second total bandwidth of the combined digital signal is less than the threshold bandwidth.
